(19) United States
(12) Patent Application Publication
(10) Pub. No.: US 2014/0262610 A1
(43) Pub. Date: Sep. 18, 2014

(54) Systems for Assisted Braking Belay with a Lever Disengagement Mechanism

(71) Applicants: Paul Oddou, Salt Lake City, UT (US); Jake Hall, Draper, UT (US); Bill Belcourt, Salt Lake City, UT (US); Ben Walker, Draper, UT (US)

(72) Inventors: Paul Oddou, Salt Lake City, UT (US); Jake Hall, Draper, UT (US); Bill Belcourt, Salt Lake City, UT (US); Ben Walker, Draper, UT (US)

(73) Assignee: BLACK DIAMOND EQUIPMENT, LTD., Salt Lake City, UT (US)

(21) Appl. No.: 14/206,418

(22) Filed: Mar. 12, 2014

Related U.S. Application Data
(60) Provisional application No. 61/785,770, filed on Mar. 14, 2013.

(51) Int. Cl. A62B 1/14

(52) U.S. Cl. CPC A62B 1/14
USPC 182/5

(57) ABSTRACT

One embodiment of the present invention relates to an assisted braking belay system with a housing, a camming mechanism, and a lever mechanism with a lever disengagement mechanism. The housing may include a substantially enclosed rope channel through which a rope may extend to the climber. The camming mechanism is moveably coupled to the housing and configured to automatically engage a camming surface upon the rope across the rope channel if the rope translates through the channel at a particular speed. The lever mechanism enables a belayer to selectively disengage the camming mechanism and release the camming surface from the rope thereby allowing the rope to translate through the rope channel. The lever disengagement mechanism is configured to automatically disengage the lever mechanism from the camming mechanism thereby enabling the camming mechanism to automatically reengage the camming surface upon the rope across the channel.

### RELATED APPLICATIONS

This application claims priority to U.S. provisional application Ser. No. 61/785,770 filed Mar. 14, 2013, the contents of which are incorporated by reference.

### FIELD OF THE INVENTION

The invention generally relates to belay devices with assisted braking, self-arresting belay devices, and automatic locking belay devices for climbing related activities. In particular, the present invention relates to an assisted braking belay system with a lever disengagement mechanism.

### BACKGROUND OF THE INVENTION

A belay device is used by a belayer in the act of belaying a climber. During general operation, the belay device is coupled to the belayer, who feeds excess rope to the climber through the belay device as the climber ascends. In the event that the climber falls, the belayer and belay device selectively hold or lock a region of the rope, thereby tensioning the rope between the belayer and climber and arresting the climber's fall. Belay devices are also used to lower the climber by controlling the speed at which excess rope is fed through the belay device while the rope is under tension from the climber's weight.

One type of belay device is generally referred to as a belay device with assisted braking, a self-arresting belay device, an automatic belay device, and/or an auto-locking belay device because it contains a mechanism to automatically increase the friction on the rope in the event of a climber fall. A second type of belay device is referred to as passive because it requires the belayer to manually act to increase the friction on the rope in the event of a climber fall. For safety reasons, an auto-locking belay device is preferred because it increases the likelihood of arresting a climber's fall despite the actions of the belayer. A common type of auto-locking belay system includes some form of camming mechanism or surface. To enable the belayer to selectively feed rope in a controlled manner while the rope is under tension (i.e. lower the climber), the system also generally includes a lever mechanism. The lever mechanism enables the belayer to selectively disengage the camming mechanism or surface from the rope to reduce friction and allow rope to feed through the device, thereby lowering the climber. Lever mechanisms generally include a retractable elongated structure that enables a mechanical advantage upon the camming mechanism or surface.

One of the problems or limitations with conventional auto-locking belay devices is the ability for the lever mechanism to completely disengage the camming mechanism or surface and remove substantially all friction from the rope while the climber is being lowered. If substantially all of the friction is eliminated at the belay device while the climber is weighting the rope, the climber will likely descend at a high velocity, which may cause injury upon impact with the ground.

Therefore, there is a need in the industry for an assisted braking belay device that includes a lever disengagement mechanism that automatically reengages the camming mechanism or surface if the lever is engaged in an improper manner.

### SUMMARY OF THE INVENTION

The present invention relates to assisted braking belay systems. One embodiment of the present invention relates to an assisted braking belay system including a housing, a camming mechanism, and a lever mechanism with a lever disengagement mechanism. The housing may include a substantially enclosed rope channel through which a rope may extend to the climber. The camming mechanism is moveably coupled to the housing and configured to automatically engage a camming surface upon a rope across the rope channel if the rope translates through the channel at a particular acceleration rate. The lever mechanism enables a belayer to selectively disengage the camming mechanism and release the camming surface from the rope, thereby allowing the rope to translate through the rope channel. The lever disengagement mechanism is configured to automatically disengage the lever mechanism from the camming mechanism if the lever is over-rotated with respect to the housing, thereby enabling the camming mechanism to automatically reengage and apply friction upon the rope.

Embodiments of the present invention represent a significant advance in the field of automatic belay systems. As described above, conventional automatic belay systems generally include a lever mechanism to selectively disengage the camming mechanism while lowering the climber. Unfortunately, the belayer may over-extend the lever and disengage the camming mechanism to a degree that the climber descends at a very high speed, which may result in injury upon impact with the ground. Embodiments of the present invention incorporate a lever disengagement mechanism that automatically disengages the lever mechanism from the camming mechanism, thereby allowing the camming mechanism to automatically reengage the camming surface upon the rope and arrest the climber from further descent.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. In the Figures, the physical dimensions may be exaggerated for clarity. The same reference numerals in different drawings represent the same element, and thus their descriptions will be omitted.

FIG. 1 illustrates an automatic belay system with a lever mechanism in accordance with embodiments of the present invention;

FIG. 2 illustrates that automatic belay system of FIG. 1, further illustrating the housing in the closed state, camming mechanism in the free state, and lever mechanism in the retracted state;

FIG. 3 illustrates that automatic belay system of FIG. 1, further illustrating the housing in the open state, camming mechanism in the free state, and lever mechanism in the retracted state;

FIG. 4 illustrates that automatic belay system of FIG. 1, further illustrating the housing in the open state, camming mechanism in the free state, and lever mechanism in the retracted state;

FIG. 5 illustrates that automatic belay system of FIG. 1, further illustrating the housing in the closed state, camming mechanism in the free state, and lever mechanism in the extended state;

FIGS. 6-9 illustrate cross-sectional partial transparent state views of the automatic belay system illustrated in FIG. 1, further illustrating the sequential extension of the lever mechanism;

FIG. 10 illustrates a cross-sectional partial transparent state view of the automatic belay system illustrated in FIG. 1, further illustrating the lever disengagement mechanism; and

FIG. 11 illustrates a cross-sectional partial transparent state view of the automatic belay system illustrated in FIG. 1, further illustrating the resetting of the lever mechanism.

### DETAILED DESCRIPTION OF THE INVENTION

One embodiment of the present invention relates to an assisted braking belay system including a housing, a camming mechanism, and a lever mechanism with a lever disengagement mechanism. The housing may include a substantially enclosed rope channel through which a rope may extend to the climber. The camming mechanism is moveably coupled to the housing and configured to automatically engage a camming surface upon a rope across the rope channel if the rope translates through the channel at a particular accelerate rate. The lever mechanism enables a belayer to selectively disengage the camming mechanism and release the camming surface from the rope, thereby allowing the rope to translate through the rope channel. The lever disengagement mechanism is configured to automatically disengage the lever mechanism from the camming mechanism if the lever is over-rotated with respect to the housing, thereby enabling the camming mechanism to automatically reengage and apply friction upon the rope. Also, while embodiments are described in reference to an automatic belay system with a lever disengagement mechanism, it will be appreciated that the teachings of the present invention are applicable to other areas.

Reference is initially made to FIGS. 1-5, which illustrate one embodiment of an assisted braking belay system with a lever mechanism in accordance with embodiments of the present invention, designated generally at 100. The assisted braking belay system 100 is designed to be used by a belayer in the act of belaying a climber (not shown). The act of belaying a climber includes coupling the belay system to the belayer and feeding a rope 110 through the system corresponding to the rate of controlled ascent or descent of the climber. Therefore, as the climber ascends a particular distance, the belayer feeds a corresponding distance of rope. The belay system 100 may be referred to as automatic or assisted because it includes at least one mechanism that automatically locks or applies a high degree of friction upon a section of the rope 110 if the rope accelerates or jerks above a particular rate. For example, if the climber falls, the climber's falling force will impart tension on the rope, thereby causing the rope to accelerate or jerk through the system 100 at a particular rate.

The system 100 generally includes a housing 120, a camming mechanism 140, and a lever mechanism 160. The housing 120 includes an open state (FIGS. 3-4) and a closed state (FIGS. 1-2). The camming mechanism 140 includes a cammed state (FIGS. 5-8 and 10-11) and a free state (FIGS. 1-4 and 9). The lever mechanism 160 includes an extended state (FIGS. 5-11) and a retracted state (FIGS. 1-4). For simplicity, specific figures are utilized to illustrate the components and operations of the housing 120, camming mechanism 140, and lever mechanism 160. The components of the housing 120 are specifically illustrated and designated in detail in FIG. 4. The components of the camming mechanism 140 are specifically illustrated and designated in detail in FIG. 3. The components of the lever mechanism 160 and lever disengagement mechanism are specifically illustrated and designated in FIGS. 5-11. The housing 120 further includes a rope channel 128, a top plate 124, a bottom plate 122, an opening 130, and a coupler 126. The open state of the housing 120 illustrated in FIG. 4 includes the top plate 124 rotated or pivoted about the coupler 126 from the bottom plate 122. The top plate 124 may be rotatably coupled to the bottom plate 122 at an off-axis angle to enable the top plate to articulate over the camming mechanism 140 and clutch mechanism 160 in the closed state. The term off-axis angle refers to an angle that is at least five degrees off orthogonal to the lengthwise axis of the housing 120. For example, FIG. 3 illustrates the housing 120 with a substantially horizontal axis, and the top plate 124 is configured to rotate about an axis that is at least five degrees off planar. The optional off-axis angle provides a greater internal region between the top and bottom plates 124, 122, thereby providing more space for the camming mechanism 140 and clutch mechanism 160 in the closed state of the housing 120.

In operation, the open state of the housing 120 is used to load a rope 110 into the rope channel 128 (FIG. 3). A user specifically orients the rope in a clockwise manner extending to the climber. The illustrated left end or clockwise termination of the rope channel 128 should be configured with a rope 110 portion that extends directly to the climber. Likewise, the illustrated right end or clockwise initiation of the rope channel 128 should be configured with a rope 110 portion that does not extend to the climber. Initially, the user loads the rope 110 into the rope channel 128 of the bottom portion 122 of the housing 120 in the clockwise orientation illustrated and described. The user then rotates or pivots the top plate 124 over the bottom plate 122 (ie. counter-clockwise rotation), thereby substantially engaging the closed state of the housing 120 by enclosing the rope 110 within the rope channel 128 between the top plate 124 and the bottom plate 122. The closed state of the housing 120 also includes aligning the opening 130 on both the top and bottom plates 124, 122. A user may extend a carabiner or other releasable coupling device through the aligned openings 130 and the user's harness (not shown) so as to couple the system 100 to the user or belayer. The act of extending a coupler through the openings 130 of both the top and bottom plates 124, 122 locks the housing 120 into the closed state by preventing the top plate 124 from rotating and/or exposing the rope 110 and rope channel 128. This form of releasably coupling and securing an assisted braking belay system to a user/belayer is well known to those skilled in the art.

The automatic or assisted braking mechanism is the camming mechanism 140, which includes a free state (FIG. 3) and a cammed state (FIGS. 5-6). The camming mechanism 140 is biased toward the free state by some form of biasing mechanism. The camming mechanism 140 is shaped and oriented within the system 100 such that it is in a translatable communication with the rope 110 as it translates through the belay system. The components of the camming mechanism 140 are illustrated and designated in detail in FIG. 3. The illustrated camming mechanism 140 includes a camming surface 142, a bearing surface 144, and a camming rotation point 146. The camming mechanism 140 may be transitioned from the free state to the cammed state by overcoming a biasing force and rotating about the camming rotation point 146 with respect to the bottom plate 122 of the housing. The bearing surface 144 is oriented and shaped such that a clockwise manual translation of the rope 110 through the rope channel 128 forces the rope 110 to contact and impart a force upon the bearing surface 144. The bearing surface 144 may be concave-shaped and protrude into the rope channel 128 for purposes of maintaining translational forces of the rope 110 upon the bearing surface 144. The maintenance of translation forces enables the bearing surface 144 to essentially detect the acceleration rate of the rope 110 through the rope channel 128. Therefore, if the translational acceleration rate of the rope 110 exceeds a particular amount or if the rope 110 is jerked in a particular manner, a rotational force is created on the camming mechanism 140 that exceeds the biasing force. Therefore, the camming mechanism 140 will rotate about the camming rotation point 146 with respect to the housing 120 so as to pivot or engage a portion of the camming surface 142 upon the rope 110 within the rope channel 128 (ie. transition from the free state to the cammed state). The engagement of the camming surface 142 upon the rope 110 (cammed state) may include translating a portion of the camming surface 142 across the rope channel 142 and restricting the rope channel 128 cross-sectional area, thereby increasing a translational friction force upon the rope 110 between the camming surface 142 and the housing 120. As the rope channel 128 is cross-sectionally restricted to a diameter smaller than the diameter of the rope 110, the translational friction force upon the rope 110 will increase and the translational rate of the rope 110 will decrease. The engagement of the cammed state may eventually entirely arrest the rope 110 translation through the rope channel 128 of the system 100 once a sufficient amount of translational friction force is applied to the rope 110 with respect to a rope 110 translation rate prior to engagement. The camming surface 142 and bearing surfaces 144 are also shaped and configured with respect to the rope channel 128 such that once the rope is arrested, the cammed state will be maintained while a sufficient tensile strength is maintained on the rope 110. The specific shape of the bearing surface 144, camming surface 142, cam rotation point 146, biasing mechanism, and rope channel 128 all contribute to the detection of the minimum rope translation acceleration rate or jerk upon the bearing surface 144. The camming mechanism 140 further includes a lever 148 intercoupled with the camming surface 142 and bearing surface 142 to provide a mechanical rotational advantage. The lever 142 may be used by the user to rotate the camming mechanism 140 with respect to the housing 120 to enable selective clockwise rope 110 translation while a particular tensile force is still on the rope 110. In addition, the camming mechanism 140 is configured to automatically transition from the cammed state to the free state once a particular tensile force is removed from the rope 110. It will be appreciated that various alternative camming mechanism 140 designs may be implemented in accordance with embodiments of the present invention, such as alternative camming/bearing surface shapes, coupling orientations, coupling frictional forces, etc. One skilled in the art will understand the operation of the camming mechanism 140 from the description above and the referenced figures.

In operation, the rope 110 is properly loaded into the rope channel 128, the housing 120 is in the closed state, the camming mechanism 140 is in the biased free state, and the system 100 is releasably coupled to the user/belayer. The belayer is able to sequentially feed or translate rope in a clockwise manner to the climber to enable ascent. If the climber falls, the rope 110 will accelerate or jerk through the system 100, causing a force upon the bearing surface 144. Once the force upon the bearing surface 144 overcomes the biasing force, the camming mechanism 140 will rotate, causing the camming surface to translate across the rope channel and impart a frictional force upon the rope 110. Once the frictional force upon the rope overcomes the translational force, the rope translation will cease, thereby fixing the rope length between the belayer and climber. The tensile force of the rope will maintain the cammed state and prevent further rope translation. This rope length fixing between the belayer and climber will have the effect of arresting the climber's fall and ceasing any further descent. The climber may resume climbing, thereby removing the tensile force upon the rope and causing the camming mechanism 140 to automatically rotate back to the free state via the biasing force. Alternatively, the belayer may activate the lever mechanism 160 to partially rotate the camming mechanism 140 toward the free state and allow the rope to translate through the system 100 at a controlled rate. The controlled translation of the rope 110 enables the belayer to lower the climber.

Reference is next made to FIG. 5, which illustrates a view of the automatic belay system of FIGS. 1-4 with the housing in the closed state, camming mechanism in the cammed state, and the lever mechanism 160 in the extended state. The lever mechanism 160 includes a lever disengagement mechanism (described below in reference to FIGS. 6-11), a lever arm 162, and a housing coupling 168. The lever mechanism 160 is rotatably coupled to the housing 120 about the housing coupling 168 with an extended state (FIG. 5) and a retracted state (FIGS. 1-4). The rotatable coupling between the lever mechanism 160 and the housing 120 is spring-biased toward the retracted state. The extended state of the lever mechanism 160 creates a coupling between the lever arm 162 and the camming mechanism 140. The extended state of the lever mechanism 160 includes a specific range of angles of the lever arm 162 with respect to the camming mechanism 140, across which the lever arm 162 and the camming mechanism 140 are coupled. The coupling between the lever arm 162 and the camming mechanism 140 causes a rotation of the lever arm 162 to correspondingly/dependently rotate the camming mechanism 140. The coupling scheme between the lever arm 162 and the camming mechanism 140 may further be described as “unidirectional”, “releasable”, and “one-way”. The term “unidirectional” refers to the coupling only permitting a single direction for joined rotation. For example, as the lever is rotated in a lever extension rotation 172 direction (clockwise in FIG. 5), the camming mechanism 140 will be correspondingly rotated in a cam free rotation 152 direction (clockwise in FIG. 5) with respect to the housing 120 (see FIGS. 6-8). In contrast, the lever retraction rotation 174 direction (FIG. 11) will not affect the camming mechanism 140, and therefore the coupling may be described as “unidirectional”. Likewise, the coupling between the lever arm 162 and the camming mechanism 140 is “releasable” because it is only engaged across certain rotational angles and may be released by the lever disengagement mechanism (FIG. 9-10). Prior to the specific range of rotational angles of the lever arm 162 with respect to the camming mechanism 140, the lever arm 162 rotation does not affect the camming mechanism (ie. not coupled or independently rotatable). Finally, the coupling is “one-way” because the camming mechanism 140 may be rotated from the cammed state to the free state without correspondingly rotating the lever arm 162.

The lever arm 162 is substantially L shaped with an elongated section and a coupling section. The illustrated elongated section includes an optional elongated recess which reduces weight but does not otherwise effect functionality. The elongated section extends from the camming mechanism at least as long as the lengthwise dimension of the camming mechanism (FIG. 7). The lever arm 162 is shaped and coupled in a specific configuration to enable a mechanical advantage for rotation of the camming mechanism 140 when the lever mechanism 160 is extended. As described above and during operation, the lever mechanism 160 may be selectively extended by the belayer when the camming mechanism 140 is in the cammed state (ie. after a fall) and the belayer wishes to selectively allow the rope 110 to translate through the system (ie. lowering the climber). The belayer thereby rotates the lever arm 162 a particular angle or amount with respect to the camming mechanism 140 to the extended state, thereby causing the coupling between the lever arm 162 and the camming mechanism 140. The belayer may then continue rotating the lever 162 to selectively release the camming surface 142 from the rope 110 toward the free state. Once the lever arm 162 is rotated more than a particular angle or amount with respect to the camming mechanism 140 or the housing 120, the lever disengagement mechanism will disengage the coupling between the lever arm 162 and the camming mechanism 140. The camming mechanism 140 will then automatically reengage the cammed state if either the rope maintains certain friction with the camming surface or if the rope accelerates or jerks in a particular manner. The lever disengagement mechanism will then permit the lever arm 162 to further rotate in the lever extension rotation 172 direction without affecting the camming mechanism. The lever disengagement mechanism will also permit the lever arm 162 to be reset by rotating in the lever retraction rotation 174 direction back to the retracted state of the lever mechanism 160. The specific operation of the lever mechanism 160 and lever disengagement mechanism will be further described below in reference to the cross-section and partially transparent views sequentially illustrated in FIGS. 6-11.

Reference is next made to FIG. 6-11 which illustrate an operational sequence of the lever mechanism 160 and lever disengagement mechanism with respect to the camming mechanism 140, housing 120, and system 100. The lever disengagement mechanism further includes a lever link 164 and a cam link 166 disposed between the lever arm 162 and the camming mechanism 140. The lever link 164 and cam link 166 are positive geometrical members having a particular relative rotational position, orientation, and shape. Because of the internal positioning of the links 164, 166, certain components are made partially transparent for illustration. The lever link 164 is coupled to an interior surface of the lever arm 162. The cam link 166 is coupled to an interior surface of the cam mechanism 140. The geometric shape of the lever link 164 and cam link 166 correspond to the coupling of the lever arm 162 to the cam mechanism 140 across specific rotational angles. In addition, the lever disengagement mechanism may include a link recess 170 within the bottom plate 122 of the housing 120. The operational states illustrated in FIG. 6-11 represent the most common sequence of usage and automatic operation of the lever mechanism 160 and lever disengagement mechanism, but it will be appreciated that other uses and/or operational sequences may be performed in accordance with embodiments of the present invention. The cross-sectional views are specifically sliced, made transparent, and otherwise manipulated to illustrate essential components of the system and are not necessarily to scale, nor do they necessarily represent actual operational scenarios. It will be appreciated that although the rope 110 is not illustrated in FIGS. 6-11, the operation of the camming mechanism 140 in part depends on the rope 110.

Reference is next made to FIG. 6, which illustrates the camming mechanism 140 in the cammed state and the lever arm 162 rotated in the lever extension rotation 172 direction. FIG. 6 illustrates a non-extended state of the lever mechanism 160 because the lever arm 162 has not yet been rotated in the lever extension rotation 172 direction a sufficient amount or angle with respect to the camming mechanism 140 to cause the coupling between the lever arm 162 and the camming mechanism 140. The lever link 164 is rotationally separated from the cam link 166, thereby preventing the coupling between the lever arm 162 and camming mechanism 140. The links 164, 166 are specifically orientated such that the lever arm 162 may be rotated from the entirely retracted position (FIGS. 1-4) to the illustrated position without affecting the camming mechanism 140. The camming mechanism 140 therefore remains in the illustrated cammed state. One of the reasons for the minimum lever arm 162 rotation prior to coupling is the proper orientation of the elongated portion of the lever arm 162 with respect to the camming mechanism 140 and coupling scheme between the camming mechanism 140 and the housing 120. As discussed above, the lever arm 162 must generate a mechanical advantage over the camming mechanism 140, and therefore maximum leverage is achieved by extending the elongated portion furthest from the rotation point 146 between the camming mechanism 140 and housing 120.

Reference is next made to FIGS. 7-8 which illustrate the camming mechanism 140 in the cammed state and the lever arm 162 rotated further in the lever extension rotation 172 direction. The lever link 164 is rotated via the lever arm 162 to a position rotationally adjacent to the cam link 166, thereby engaging the coupling between the lever arm 162 and the camming mechanism 140. FIG. 8 specifically illustrates how the lever arm 162 is rotated about the housing coupling 168 but is also rotated with respect to the camming mechanism 140. The links 164, 166 are specifically shaped and oriented on the lever arm 162 and camming mechanism 140 to bear on one another and create the rotational coupling between the lever arm 162 and the camming mechanism 140. As described above, the coupling is “unidirectional”, “releasable”, and “one-way”. The coupling is “unidirectional” because it only permits a single direction for joined rotation. Likewise, the coupling is “releasable” because it is only engaged across certain rotational angles and may be released by the lever disengagement mechanism. Finally, the coupling is “one-way” because the camming mechanism 140 may still be rotated without the lever arm 162. The angle of the lever arm 162 elongated portion is substantially oriented to maximize the spacing from the cam rotation point 146 to induce the mechanical advantage discussed above that enables a user to release the camming mechanism 140. Therefore, the relative positioning of the links 164, 166 correspond to the mechanical advantage of the lever arm 162 with respect to the camming mechanism 140. The engagement of the links 164, 166 and the resulting rotational coupling between the lever arm 162 and the camming mechanism 140 allow a user to rotate the lever arm 162 in the lever extension rotation 172 direction and cause the camming mechanism 140 to correspondingly rotate in the cam free rotation 152 direction.

Reference is next made to FIG. 9 which illustrates the camming mechanism 140 substantially in the free state and the lever arm 162 rotated further in the lever extension rotation 172 direction. The coupling between lever mechanism 160 and the camming mechanism 140 via the lever link 164 and cam link 166 is maintained as the lever arm 162 is rotated from the position illustrated in FIGS. 7-8 to the position illustrated in FIG. 9. The rotation of the lever arm 162 from the position illustrated in FIGS. 7-8 to the position in FIG. 9 allows the user to translate the camming mechanism 140 to the substantial free state via rotation about the cam rotation point 146. It will be appreciated that the free state of the camming mechanism 140 refers to a range of angles of the camming mechanism 140 with respect to the housing 120. The illustrated free state of the camming mechanism 140 includes translating the camming surface 142 from the rope channel 128, permitting a rope 110 (not shown) to translate with minimal friction. However, the lever link 164 and cam link 166 are about to rotationally translate past one another, thereby engaging the lever disengagement mechanism. The links 164, 166 are shaped and oriented to maintain a bearing coupling upon one another as the lever arm 162 is rotated across the angles corresponding to FIGS. 7-8 through FIG. 9. The cam link 166 is rotated into the link recess 170 of the housing in FIG. 9. The lever disengagement mechanism includes the specific shape, position, orientation, and alignment of the links 164, 166 to maintain the coupling between the lever mechanism 160 and the camming mechanism 140 across the range of lever arm 162 rotation and/or angles between FIGS. 7-9. The spring biasing mechanism which biases the lever in the retracted position also prevents jamming as the lever link slips past the cam link.

Reference is next made to FIG. 10 which illustrates the camming mechanism rotated in the cam camming rotation 150 about the cam rotation point 146 back to the cammed state after the lever disengagement mechanism disengaged the coupling between the lever mechanism 160 and the camming mechanism 140. In particular, the lever disengagement mechanism includes the shape, position, orientation, and alignment of the links 164, 166 to allow the lever link 164 to rotationally translate past (ie. slip) the cam link, thereby disengaging the coupling between the lever mechanism 160 and the camming mechanism 140. The camming mechanism 140 independently returned to cammed state as a result of the rope 110 (not shown). Since the lever arm 162 is disengaged from the camming mechanism 140 as a result of the lever disengagement mechanism, the lever arm 162 is able to independently rotate in the lever extension rotation 172 direction to a stop in the housing. The engagement of the lever disengagement mechanism allows the camming mechanism 140 to rotate in the opposite direction of the lever arm 162 because of the disengagement of the coupling. The novel operation of the lever disengagement mechanism therefore acts as a safety mechanism to reengage the automatic braking assistance of the camming mechanism in the event of the lever arm 162 being rotated beyond an acceptable angle.

Reference is next made to FIG. 11, which illustrates resetting the lever mechanism 160 with respect to the camming mechanism 140 after the lever disengagement mechanism was engaged (FIG. 10). The lever arm 162 is rotated in the lever refraction rotation 174 direction toward the retracted state illustrated in FIGS. 1-4, and the lever links 164, 166 are rotationally translated past one another. The camming mechanism 140 is independently functioning and in the cammed state resulting from the lever disengagement mechanism. The lever disengagement mechanism includes the shape, position, orientation, and alignment of the links 164, 166 to permit the reset of the lever mechanism 160 and lever arm 162 back toward the refracted state. Resetting the lever disengagement mechanism means that the belayer may then proceed with re-rotating the lever away from the housing to the extended position so as to re-engage the lever link with the cam link. It is not necessary to completely rotate the lever arm 162 back to the retracted state illustrated in FIGS. 1-4 to reset the lever disengagement mechanism of the illustrated embodiment. As the lever arm 162 is rotated in the lever retraction rotation 174 back to reset the lever disengagement mechanism, the lever link 164 will automatically rotate within the lever arm 162 to facilitate sliding around the cam link 166 and prevent binding. Therefore, if a user accidently rotates the lever arm 162 beyond the acceptable range (FIG. 10), the lever mechanism 160 may be reset by rotating the lever arm 162 back toward the retracted position a particular amount to translate the lever link 164 past the cam link 166. After the lever arm 162 is reset back toward the retracted state, the user may resume operation of the lever mechanism 160 (FIG. 6-9).

It should be noted that various alternative system designs may be practiced in accordance with the present invention, including one or more portions or concepts of the embodiment illustrated in FIG. 1 or described above. Various other embodiments have been contemplated, including combinations in whole or in part of the embodiments described above. One non-illustrated alternative embodiment includes an alternative lever disengagement mechanism, including a translating lever link that levers off the back plate of the device rather than a portion of the camming mechanism. The lever link slides in and out of the camming mechanism to allow engagement/disengagement between the lever and the camming mechanism. The alternative lever disengagement mechanism does not depend on different rotations of the camming mechanism with respect to the housing. Rather, the mechanism depends on lever link rotation with respect to the back plate, which pushes the translating piece into a recess in the lever until there is no longer contact with camming mechanism. Another non-illustrated alternative embodiment includes a lever disengagement mechanism in which the lever is rotatably coupled to the camming mechanism rather than the housing, and the lever link leverages off the back plate.

What is claimed is:

1. An assisted braking belay system comprising:
a housing including a rope channel, top plate, and bottom plate, wherein the top plate is rotatable between an open state and closed state with respect to the bottom plate, and wherein the rope channel is substantially enclosed between the top plate and bottom plate in the closed state;
a camming mechanism moveably coupled to the housing adjacent to the rope channel, wherein the camming mechanism includes a camming surface, and wherein the camming mechanism is configured to rotate between a biased free state and a cammed state with respect to the housing, and wherein the cammed state includes translating the camming surface across the rope channel and constricting a portion of the rope channel; and
a lever mechanism configured to rotate between an extended state and a refracted state with respect to the camming mechanism, and wherein the extended state of the lever mechanism includes a coupling between the lever mechanism and the camming mechanism such that rotating the lever mechanism causes the camming mechanism to correspondingly rotate from the cammed state to the free state with respect to the housing and the camming surface to correspondingly translate away from across the rope channel; and
wherein the lever mechanism includes a lever disengagement mechanism configured to disengage the coupling between the lever mechanism and the camming mechanism if the lever mechanism is rotated above a particular amount with respect to the housing.

2. The system of claim 1, wherein the lever disengagement mechanism is configured to automatically engage the cammed state of the camming mechanism if the lever mechanism is rotated beyond a particular amount with respect to the housing.

3. The system of claim 1, wherein the extended state of the lever mechanism only includes a coupling between the lever mechanism and the camming mechanism if the camming mechanism is in the cammed state.

4. The system of claim 1, wherein the lever disengagement mechanism is configured to disengage the coupling between the lever mechanism and the camming mechanism if the lever mechanism is rotated beyond a particular amount with respect to the camming mechanism.

5. The system of claim 1, wherein the lever disengagement mechanism is configured to disengage the coupling between the lever mechanism and the camming mechanism if the camming mechanism is rotated by the lever mechanism above a particular amount with respect to the housing.

6. The system of claim 1, the lever mechanism is rotatable about a first coupling point on the housing and the camming mechanism is rotatable about a second coupling point on the housing, and wherein the first and second coupling points are substantially separated.

7. The system of claim 1, wherein the lever mechanism is rotatably coupled to the bottom plate of the housing.

8. The system of claim 1, wherein the lever mechanism is in rotatable communication with the camming mechanism.

9. The system of claim 1, wherein the extended state of the lever mechanism includes rotating the lever mechanism a particular minimum amount with respect to the camming mechanism.

10. The system of claim 1, wherein the extended state of the lever mechanism is configured to generate a rotational mechanical advantage over the camming mechanism in the cammed state with respect to the housing.

11. The system of claim 1, wherein lever disengagement mechanism includes a lever link disposed on a lever arm of the lever mechanism and a cam link disposed on the camming mechanism, and wherein the lever link is configured to engage with the cam link of the camming mechanism in the extended state of the lever mechanism and the cammed state of the camming mechanism, and wherein the lever link is configured to disengage with the cam link of the camming mechanism if the camming mechanism is rotated beyond a particular angle with respect to the housing.

12. The system of claim 11, wherein the cam link and lever link are correspondingly shaped to engage if the camming mechanism is in the cammed state and the lever arm is rotated between a particular range of angles with respect to the camming mechanism.

13. The system of claim 11, wherein the cam link and lever link are correspondingly shaped to translate past one another if the lever arm is rotated above a particular range of angles with respect to the camming mechanism.

14. The system of claim 11, wherein the cam link and lever link are disposed between the camming mechanism and the lever arm.

15. The system of claim 11, wherein the lever arm is substantially L shaped.

16. The system of claim 1, wherein lever mechanism is rotatably coupled to the camming mechanism independent of the housing.

17. The system of claim 1, wherein the lever mechanism is independently rotatable of the camming mechanism in the retracted state.

18. The system of claim 1, wherein if the camming mechanism is in the cammed state and the lever mechanism is in the extended state, the lever mechanism and camming mechanism are in part dependently rotatable.

19. An assisted braking belay system comprising:
a housing including a rope channel, top plate, and bottom plate, wherein the top plate is rotatable between an open state and closed state with respect to the bottom plate, and wherein the rope channel is substantially enclosed between the top plate and bottom plate in the closed state;
a camming mechanism moveably coupled to the housing adjacent to the rope channel, wherein the camming mechanism includes a camming surface, and wherein the camming mechanism is configured to rotate between a biased free state and a cammed state with respect to the housing, and wherein the cammed state includes translating the camming surface across the rope channel and constricting a portion of the rope channel; and
a lever mechanism configured to rotate between an extended state and a refracted state with respect to the camming mechanism, and wherein the extended state of the lever mechanism includes a coupling between the lever mechanism and the camming mechanism such that rotating the lever mechanism causes the camming mechanism to correspondingly rotate from the cammed state to the free state with respect to the housing and the camming surface to correspondingly translate away from across the rope channel; and
wherein the lever mechanism includes a lever disengagement mechanism configured to disengage the coupling between the lever mechanism and the camming mechanism if the lever mechanism is rotated above a particular amount with respect to the camming mechanism.

20. An assisted braking belay system comprising:
a housing including a rope channel, top plate, and bottom plate, wherein the top plate is rotatable between an open state and closed state with respect to the bottom plate, and wherein the rope channel is substantially enclosed between the top plate and bottom plate in the closed state;
a camming mechanism moveably coupled to the housing adjacent to the rope channel, wherein the camming mechanism includes a camming surface, and wherein the camming mechanism is configured to rotate between a biased free state and a cammed state with respect to the housing, and wherein the cammed state includes translating the camming surface across the rope channel and constricting a portion of the rope channel; and
a lever mechanism configured to rotate between an extended state and a refracted state with respect to the camming mechanism, and wherein the extended state of the lever mechanism includes a coupling between the lever mechanism and the camming mechanism such that rotating the lever mechanism causes the camming mechanism to correspondingly rotate from the cammed state to the free state with respect to the housing and the camming surface to correspondingly translate away from across the rope channel; and
wherein the lever mechanism includes a lever disengagement mechanism configured to automatically engage the cammed state of the camming mechanism if the lever mechanism is rotated above a particular amount with respect to the housing.
